(19) United States
(12) Patent Application Publication
(10) Pub. No.: US 2004/0131821 A1
(43) Pub. Date: Jul. 8, 2004

(54) Lint-free towels

(76) Inventor: Rajesh Mandawewala, Mumbai (IN)

Correspondence Address: PATREA L. PABST, HOLLAND & KNIGHT LLP, SUITE 2000, ONE ATLANTIC CENTER, 1201 WEST PEACHTREE STREET, N.E., ATLANTA, GA, 30309-3400, US

(21) Appl. No.: 10/412,790

(22) Filed: Apr. 10, 2003

Related U.S. Application Data
(60) Provisional application No. 60/438,564, filed on Jan. 6, 2003.

(51) Int. Cl. B32B 33/00; D03D 27/00; D02G 3/02

(52) U.S. Cl. 428/97; 57/236; 57/238; 26/2 R

(57) ABSTRACT

Towels which produce little to no lint (herein referred to as “lint-free”) and methods for making such towels are described herein. The lint-free towels contain a small amount of short cotton fibers in the pile yarn and the pile yarn contains a low twist factor. In the preferred embodiment, 24% or more of the noil is removed when the pile yarn is produced. This combination of low twist factor with few short cotton yarn, results in soft, absorbent, lint-free towels. Preferably, the lint-free towels contain yarn with a hairiness index of 5 to 7.5. The lint-free towels are produced by twisting the pile yarn with a poly vinyl alcohol (PVA) spun yarn. After weaving the yarns to form a towel, the PVA yarn is then dissolved during the production process, leaving twistless pile yarn.

### CROSS-REFERENCE TO RELATED APPLICATIONS

This application claims priority to U.S. Application No. 60/438,564, filed Jan. 6, 2003, entitled “Lint-Free Towels” to Rajesh Mandavewala.

### FIELD OF THE INVENTION

The present invention relates to processes for making towels. In particular, the invention is directed at producing lint-free towels.

### BACKGROUND OF THE INVENTION

Lint is a soft material of linen or cotton which contains fluff and scraps of yarn. Many towels are made of 100% cotton yarns in the ground warp, pile loops and the interlacing weft, and therefore these towels produce a lot of lint.

The amount of twisting in the yarn affects the properties of the towel and the amount of lint that the towel produces. The pile yarn is generally a low-twist yarn. The pile loops provide maximum surface area for the absorption of water, and the low twist aids in the absorption by imparting wicking properties to the yarn. The ground warp and the weft are generally hard-twisted compared to the pile yarn. The ground and weft yarn twist factors generally range from 3.8 to 4.1, depending upon the towel construction. In contrast, the twist factor in the pile yarn generally ranges from about 3.2 to 3.6. The lower the twist factor in the pile yarn, the softer and thicker the towel.

Towels are generally thick materials. The thicker the towel, the greater the surface area, and thus a greater amount of water can be absorbed.

In the towels the normal reed varies from 56 dents/inch and 60 to 76 dents/inch, but does not exceed 76. Similarly the number of picks per inch varies from 35 to 52.

The cover factor indicates the degree of closing or cover provided by the yarns. The warp cover factor is calculated using the following formula (I):

Warp cover factor=Number of ends per inch/square root of warp count (Ne) (I)

The weft cover factor is calculated in a similar manner, using the following formula (II):

Weft cover factor=Number of picks per inch/square root of weft count (Ne) (II)

Therefore, as the number of ends per inch or picks per inch increases due to finer counts, the cover factor also increases. Generally in towels, the counts are coarse and the number of ends and picks per inch are also limited to balance the weight of the towel, measured in grams per square meter (GSM). Therefore, the cover factors in a towel are low. The typical yarn counts used in ground warp are 2/20s, 2/24s, 10s, 12s in English cotton number (Ne), which yield a warp cover factor ranging from 16 to 24. The normal weft count used in towels is Ne 12s or 16s, which yield a cover factor ranging from 8.75 to 16.75.

These cover factors are not high cover factors and the fabric contains lot of space between the yarns in the fabric. This provides a large surface area, which increases the absorbency of the towel. However, such low cover factors also produce towels with a great tendency to shed fibers and produce lint.

Another source of lint is due to the hairiness of the yarn. When the cotton fiber are twisted in the ring spinning system, the fibers follow a helical path and due to centrifugal force during twisting, the end of the fibers protrude on the yarn surface, like hairs. The more short fibers used in making the yarn, the hairier the yarn becomes. The hairier the yarn, the more fibers dislodge during washing of the towels resulting in linting.

Sometimes the cotton lint sticks to the body of a user. The lint in towels often annoys the users of the towels.

Therefore it is an object of the invention to provide towels which minimize or prevent the production of lint.

Another object of the invention is to provide a process for making towels which produce less lint than ordinary towels.

### BRIEF SUMMARY OF THE INVENTION

Towels which produce little to no lint (herein referred to as “lint-free”) and methods for making such towels are described herein. The lint-free towels contain a small amount of short cotton fibers in the pile yarn and the pile yarn contains a low twist factor. In the preferred embodiment, 24% or more of the noil is removed when the pile yarn is produced. This combination of low twist factor with few short cotton yarns, results in soft, absorbent, lint-free towels. Preferably, the lint-free towels contain yarn with a hairiness index of 5 to 7.5.

The lint-free towels are produced by twisting the pile yarn with a poly vinyl alcohol (PVA) spun yarn. After weaving the yarns to form a towel, the PVA yarn is then dissolved during the production process, leaving twistless pile yarn.

### DETAILED DESCRIPTION OF THE INVENTION

I. Lint-Free Towels

The lint-free towels can be made in any size, including bath, hand wash and bath sheet sizes. The lint-free towels can have a variety of different designs and counts.

A. Fibers

Terry towels are formed from three types of yarn. The first type of yarn is the ground warp. The ground warp is the longitudinal set of yarn forming the base fabric. The second type of yarn is the pile warp. The pile warp is placed in the longitudinal direction and produces the pile loops on the towel surface. The pile loops provide a large surface area for maximizing the absorption of water. The third type of yarn is the weft yarn. The weft yarns are laid perpendicular to the pile yarns, and interlace with pile or ground yarn to form the fabric of the towel.

Pile Yarns

Generally the pile yarn is 100% cotton yarn. Alternatively, the pile yarn can be Spun Silk or Modal Spun Yam. Preferred cotton yarns include Indian cotton S-6, Egyptian cotton, and Australian cotton. In the most preferred embodiment, the pile yarn is a 50/50 mixture of Egyptian Cotton Giza 70 and Australian Cotton Abas. This mix provides a fiber with a long staple and low content of short fibers. Alternatively, the cotton yarn may contain 25% Egyptian cotton and 75% Shankar cotton, 25% Australian cotton and 75% Shankar cotton, or 25% Egyptian cotton, 25% Australian cotton, and 50% Shankar 6 cotton.

Table 1 provides the characteristics of the 50/50 Mixture of Egyptian Giza 70 and Australian Abas cotton fibers.

TABLE 1
CHARACTERISTICS FOR 50/50 MIXTURE OF
EGYPTIAN GIZA 70 AND AUSTRALIAN ABAS

| | | 2.5% | | | Short | | |
|---|---|---|---|---|---|---|---|
| | | Span | Strength | Uniformity | Fiber | Maturity | |
| Type of Fiber | MIC | Length | 8/tex | Ratio | Index | Coeff | Trash % |
| Giza 70 | 3.4-3.8 | 32-34 | 28-32 | 44-48 | 2.5-3.5 | 0.70-0.80 | 3.0-4.0 |
| Egyptian | | | | | | | |
| Abas | 4.2-4.7 | 28-29.5 | 20-22 | 45-47 | 4-6 | 0.68-0.72 | 1.5-2.0 |
| Australian | | | | | | | |
| 50/50 Mix | 3.8-4.2 | 28-32 | 22-24 | 44-47 | 44-47 | 0.68-0.75 | 3.0-5.0 |

During the processing of the yarn, the short fibers should be removed from the yarn. In the preferred embodiment, 24% or more of the noil is removed. The noil contains short fibers and is removed during the combing process. The removal of 24% of the noil generally effectively eliminates all the short fibers.

The pile yarn has a low Uster hairiness index. Suitable yarn has a hairiness index in the range of 5 to 7.5.

Polyvinyl Alcohol Yarn

Polyvinyl alcohol (PVA) yarn is a synthetic yarn which is easily dissolved by warm or hot water, without the aid of any chemical agents. Due to its ready solubility, these yarns can not be used for ordinary wear fabrics. Although PVA yarn is preferred, other materials which have the same or similar properties can also be used.

The counts for suitable PVA yarns cover a broad range, and include 31 Dtex, 40 Dtex, 44 Dtex, 62 Dtex, and 84 Dtex. As the filament becomes finer, the amount of PVA in the twisted yarn decreases. For example, 31 Dtex is the finest available filament and contains the smallest amount of PVA. The most preferred PVA filament is 84 Dtex. 84 Dtex PVA yarn improves the performance on the looms.

One type of PVA filament yarn is manufactured by NITIVY Co. (Japan) and marketed under the brand name SOLVRON®. These PVA yarns have shrinkage ranging from 35 to 60% when subjected to steaming under tension free conditions. Tables 2 and 3 list types of multifilament and monofilament SOLVRON® PVA yarns and their solubility, dissolution and shrinkage characteristics.

TABLE 2
TYPES OF PVA MULTIFILAMENT YARNS AND THEIR CHARACTERISTICS

| Type | SH | SM | SL | SX | SS | SP | SF | SHC** |
|---|---|---|---|---|---|---|---|---|
| *Temp. for | 95 | 95 | 70 | 60 | 30 | 25 | 55 | 90 |
| Dissolution | | | | | | | | |
| (° C.) | | | | | | | | |
| Tenacity | 3.5-4.5 | 1.5-2.5 | 3.5-6 | 2-4.5 | 3.5-4.5 | 3-4 | 3.4-4.4 | 4-5 |
| (grm/d.) | | | | | | | | |
| (Dry) | | | | | | | | |
| Elongation | 12-16 | 30-40 | 10-20 | 15-25 | 10-20 | 25-35 | 12-25 | 10-20 |
| (%) | | | | | | | | |
| Solubility | 93 ± 3 | 90 ± 3 | 50 ± 5 | 36 ± 4 | 20 ± 5 | 15 ± 5 | 36 ± 5 | 85 ± 5 |
| in Water | | | | | | | | |
| (° C.) | | | | | | | | |
| Maximum | 45-50 | 35-40 | 50-60 | 45-60 | — | — | 40-55 | 55-60 |
| Shrinkage | | | | | | | | |
| (%) | | | | | | | | |
| Temp. for | 85 | 85 | 25 | 20 | | | 20 | 75 |
| Maximum | | | | | | | | |
| Shrinkage | | | | | | | | |
| (° C.) | | | | | | | | |
| Shrinkage | 2-7 | 5-10 | 50-60 | 45-60 | — | — | — | 45-50 |
| in water at | | | | | | | | |
| 25° C. (%) | | | | | | | | |
| (Tension | | | | | | | | |
| Free) | | | | | | | | |
| Shrinking | 0.05-0.1 | 0.05-1 | 0.05-1 | 0.05-1 | — | — | — | 0.3-0.4 |
| Strength | | | | | | | | |
| (grm/d) | | | | | | | | |
| (In water at | | | | | | | | |
| 25° C.) | | | | | | | | |
| Sizes | 28 D/9F | 56D/12F | 28D/9F | 28D/9F | 56D/18F | 56D/18F | 31DT | 28D/9F |
| | 56D/18F | | 40D/12F | 40D/12F | 100D/30F | 75D/25F | 44DT | 75D/24F |
| | | | 75D/20F | 56D/18F | 200D/60F | 100D/30F | 62DT | 100D/30F |
| | | | 100D/30F | 100D/20F | | | 84DT | 225D/100F |
| | | | | 200D/40F | | | 110DT | |
| | | | | 300D/50F | | | 220DT | |
| | | | | 600D/50F | | | 330DT | |
| | | | | 600D/100F | | | 660DT | |
| | | | | 900D/150F | | | | |

*When SOLVRON ® is knitted or woven into fabrics, the temperature should be raised above the listed temperature for dissolution.
**SHC yarn shrinks in water a temperature of 25° C.
The SHC type filament requires high temperature to dissolve, i.e. 90° C. (see Table 2).

In the preferred embodiment, the PVA filament is a SL, SX, or SF type of yarn, which dissolves at a temperature within the range of 55 to 80° C. For example, the PVA filament may be: (1) 44 dtex/12 Filament SX or SF, which is soluble at 60 to 70° C. in water, with shrinkage of 45 to 60% in water at 20° C. under tension-free conditions; (2) 62 dtex/18 Filament SX or SF type soluble at 60 to 70° C. in water, with a shrinkage of 45 to 60% in water at 20° C. under tension-free conditions; or (3) 84 dtex/20 Filament SX or SF type soluble at 60 to 70° C. in water with a shrinkage of 45 to 60% in water at 25° C. under tension-free conditions.

TABLE 3
TYPES OF PVA MONOFILAMENT YARNS AND
THEIR CHARACTERISTICS

| Type | MH | ML |
|---|---|---|
| *Temp. for | 95 | 70 |
| Dissolution (° C.) | | |
| Tenacity (Dry) | 3-4 | 3-4 |
| (grm/d.) | | |
| Elongation | 15-20 | 15-20 |
| (%) | | |
| Solubility in Water (° C.) | 85 ± 5 | 60 ± 5 |
| Maximum Shrinkage (%) | 45-50 | 40-45 |
| Temp. for Maximum | 65 | 25 |
| Shrinkage (° C.) | | |
| Shrinkage in water at 25° C. | 33-38 | 40-45 |
| (%) (Tension Free) | | |
| Shrinking Strength (grm/d) | 0.1-0.13 | 0.1-0.13 |
| (In water at 25° C.) | | |
| Sizes | 30D/1F | 30D/1F |
| | 45D/1F | 45D/1F |
| | 675D/15F | |

*When SOLVRON ® is knitted or woven into fabrics, the temperature should be raised above the listed temperature for dissolution.

The preferred PVA fiber for spun yarn is 38 mm×1.4 denier PVA cut staple fibers, having a dissolution temperature of 90° C. The PVA spun yarn may be of a wide range of counts. Typical counts include Ne 30s, 40s, 50s, 60s, and 70s with a twist multiplier of 4.0.

TABLE 4
PROPERTIES OF STAPLE FIBERS FOR PVA SPUN YARN

| | Nominal | | | | |
|---|---|---|---|---|---|
| | Dissolving | | | | |
| | Temp. in | | Cut | | |
| | Water | Fineness | length | Tenacity | Elongation |
| Type | (° C.) | (dtex) | (mm) | (cN/dtex) | (%) |
| 1 | 20 | 1.7 | 38 | 5 | 20 |
| | | 2.2 | 51 | | |
| 2 | 40 | 1.2 | 38 | 7 | 15 |
| | | 1.7 | 38 | | |
| | | 2.2 | 38, 51, | | |
| | | | 75B | | |
| 3 | 50 | 1.7 | 32, 38 | 7 | 15 |
| | | 2.2 | 32, 38, 51, | | |
| | | | 75B, 85B | | |
| 4 | 70 | 1.7 | 38 | 7 | 12 |
| | | 2.2 | 51 | | |
| 5 | 80/90 | 1.4 | 32, 38 | 8 | 11 |
| | | 1.7 | 32, 38 | | |
| | | 2.2 | 51, 85B | | |
| | | 2.2 | 75B | 7 | 15 |
| 6 | 95 | 1.7 | 38 | 9 | 10 |
| | | 2.2 | 51, 75B | | |

Ground and Weft Yarns

The ground and weft yarns are typically 100% cotton yarn. Alternatively, the yarn may be Spun Silk or Modal Spun Yarn. The count covers a broad range, including Ne 10s, 12s, 14s, 16s, 18s, and 2/24s. The cotton yarn may be either combed or carded.

TABLE 5
CHARACTERISTICS OF COTTON FOR GROUND AND WEFT YARNS

| | | 2.5% | | | Short | | |
|---|---|---|---|---|---|---|---|
| | | Span | | Uniformity | fiber | Maturity | |
| Type | MIC | Length | Strength | Ratio | Index | Coeff | Trash % |
| Shankar-6 | 3.8 to 4.2 | 27 to 29 | 20 to 24 | 45 to 47 | Up to 5% | 0.65 to 0.78 | Up to 5% |
| NHH 4 | 4.2 to 4.5 | 26.5 to 28.0 | 19 to 20 | 45 to 47 | Up to 5% | 0.70 to 0.78 | Up to 5% |
| J-34 | 4.2 to 4.6 | 26.5 to 28.0 | 19 to 22 | 45 to 47 | Up to 5% | 0.70 to 0.75 | Up to 5% |

II. Method of Producing Lint-Free Towels

A. Production of the Pile Yarn

Pile yarn is prepared according to standard procedures. First, the types of cottons are selected and mixed in their desired proportions. Then the cotton is processed in the blow room, at a speed of approximately 550 kg/hr. Next the cotton is carded, with a delivery speed of 40 kg/hr and a hank of sliver of 0.12. The cotton proceeds to breaker drawing, with 6 ends up, at a speed of 400 mpm and an output hank of 0.12. Then the unilap is formed, typically with 24 ends up and a lap weight of 70 grams/meter. Next the yarn is sent to the combers. For the pile yarn the combers process the material at 350 nips/min. During the combing process, 24% noil is removed to eliminate those short fibers which are of less than 12.5 mm in length. Combing efficiency is 65%. Short fiber removal is 65%. The hank of silver is 0.12.

Then the yarn is sent to finisher drawing. The auto leveler drawing speed is about 350 mpm for pile yarn. The hank is 0.12 and the Silver U% is up to 2.5-3.0%.

Next, the yarn is sent to roving. The speed is around 1000 rpm. The hank of roving is 0.72. The TPI for the roving is 1.4. The standard package weighs 1.8-2.0 kgs.

Next, the roving is sent to ring spinning. The average speed is 14, 500 rpm. For pile yarn, the count is 12s combed and the TM is 3.8 Z twist.

Finally, the yarn is sent to the auto coners. The clearer setting is N of 500, S of 200% at 2.5 cm, L of 40% at 40 cm, and T of 30% at 30 cm. The speed of the autoconers is around 1,100 mpm.

The process should be closely monitored during spinning to provide a yarn having a lower Uster hairiness index than would be achieved with normal combed yarn. The hairiness index should be within the range of 5-7.5. For example, for combed 50/50 Egyptian and Australian cotton yarn, the typical hairiness index is 6.95 at COP stage, while such yarn would normally have a hairiness index of 9.0.

This cotton yarn is then assembled on an Assembly Winder with the PVA spun yarn (Ne 40s, 60s or 70s). For example, 70s PVA spun yarn, with a TPI of 33.4, a TM of 4.0, a CSP of 2,850, and an RKM of 18.5 may be used. The Assembly winding speed is maintained at 450 mpm. The tension of the cotton yarn is 4, while the tension of the PVA yarn is 0. Then the yarn is doubled using a Two for One (TFO) Twister. The TPI of the resulting yarn is either 2 TPI greater or 2 TPI less than the TPI for the single yarn. The yarn is twisted in the S direction. The speed of the TFO is 10,500 rpm, which results in a package output of 1.75 to 2.0 kg. The twisted yarn is then wound onto cones and sent to Warping. Warping is carried out under normal conditions. Typically during warping the tension is 40 gms and the speed is 600 mpm so that the yarn passage is smooth.

B. Production of the Weft and Ground Yarns

Weft and ground yarns are prepared according to standard procedures, such as those described above for pile yarns. However, during combing only 10-16% of the noil is removed. Typically 10%, 12%, 14%, or 16% of the noil is removed. During ring spinning, the combed ground yarn has a count of 20 S. The TM for weft yarn and ground yarn is 3.8 Z twist. Upon leaving the autoconers, the weft and ground yarn may be dyed. The dyed or grey ground yarn is then sent to warping and then to weaving. The dyed or grey weft yarn is sent directly to weaving.

C. Weaving of Pile, Weft, and Ground Yarns

The ground, weft, and pile yarns are woven together under normal conditions. No special attention is required for weaving.

D. Dissolving the PVA Fiber

After the weaving is completed, the fabric roll is scoured and dyed in the normal fashion in a fabric dyeing machine. When the material enters the dyeing machine, the operating temperature is 120° C.

The liquor ratio is a ratio of the material (weight) to water (volume). The liquor ratio should be sufficient to facilitate prompt dissolution of the PVA, while allowing free movement of the fabric. Typically the liquor ratio is 1:30.

The material is typically wound into the shape of a rope prior to entering the fabric dyeing machine. The rotation of the material is essential to promote rapid dissolution of PVA. A continual overflow of water is also desired.

After washing, the liquor is drained and fresh water is injected for rinsing to eliminate all the dissolved PVA. The water is at a temperature ranging from 55-100° C. Preferably, the water is at a high temperature, such as 95° C. The PVA coagulates during the dissolving step and promptly dissolves in hot water if the high temperature is maintained. Therefore, the fabric is rinsed in hot water after draining to wash away any PVA residue. This rinsing step also ensures that any loose fibers drain out along with the drain water.

The washed rope is then passed through padding mangle for a resin treatment, where it is padded with dimethyl, dihydroxy ethylene urea (DMDHU) at 25 g/L, a resin with magnesium chloride as a catalyst (7.5 g/L), Soft touch Softener (5 g/L), and Turbex CAN (10 g/L) to prevent loss of fiber strength.

E. Drying and Straightening the Towels

After unloading the material from the washing and rinsing vessel, the material is hydro-extracted in a Hydro-extractor in the standard manner. A rope is passed through rope opener, which is equipped with drum beaters both at feed and delivery ends, to straighten the twist in the rope. Then the material is passed two times through a hot air dryer (e.g. Alea) which is equipped with drum beaters at both the feed and delivery ends. This ensures proper lifting of the pile. The first drying is carried out at 120° C. The second drying occurs at a higher temperature, such as 150° C. for 4 to 5 minutes. The full width fabric is then passed through hot air stenter and a weft straightener to straighten the fabric and return it to its proper dimensions.

F. Shearing

The towels are then passed through the shearing machine on both the sides. The blade/laser on the shearing machine is set such that only protruding fibers are cut, but the piles are not cut. The fabric is then carried through length cutting, length hemming, cross cutting, cross hemming, checking, folding, and packing according to the standard practice.

This process produces a lint-free towel, which does not shed any fibers, even during domestic laundering.

### EXAMPLES

### Example 1

### Production of 50/50 Egyptian and Australian Cotton/PVA Pile Yarn

A 50/50 mixture of Egyptian Cotton Giza 70 and Australian Cotton Abas, with characteristics as described by Table 1 (above), was formed. The cotton was sent to the Blow Room through a Blendomat GBR, Axiflow, Asta, MM6, CVT3, Dustex. The rate of production was maintained at 550 kgs/hr. The cotton was then carded (Truetzschler DK 760), with a delivery rate of 40 kg/hr of sliver with a hank of 0.12. The sliver is a continuous strand of loosely assembled fibers without twist. The production of the sliver is the first step in the textile operation that brings the staple fiber into a form that can be drawn and eventually twisted into a spun yarn.

The carded cotton was sent to breaker drawing (Zinser 730/1) with 6 ends up and speed of 400 rpm, producing sliver with a hank of 0.12. The Unilap had 24 ends up, with a lap weight of 70 gms/meter. Then the cotton was sent to a comber (Rieter E60H), which was run at a speed of 350 nips/min, with 5.2 mm backward feed. The comber removed 24% of the noil. This resulted in a combing efficiency of 65%, short fiber removal of 65.3% and sliver with a hank of 0.12.

Then the cotton was sent to Finisher Drawing (Truetzschler: HSR 900 with short term auto leveler). The Sliver U% was 2.5; the speed was set at 350 rpm; and the hank was 0.12. Next the cotton was sent to a Speed Frame (Toyota FL 100), which operated at a speed of 1,000 rpm and produced yarn with a hank of roving of 0.72. This step produced yarn with a TPI of 1.4. Then the yarn was sent to Ring Spinning (Toyota RXI 240) with SKF PK 2025 drafting. This produced Ne 12s combed yarn with a TPI of 13.16, and a TM of 3.8 (‘Z’ Twist). The Spindle Speed was 14,500.

Finally, the yarn was send to an Autoconer (Schlafhorst 238 with Uster Quantum), which was set at a clearer setting, N—500, S—200% at 2.5 cm, L—40% at 40 cm, T—30% at 30 cm; and a Speed of 1,100 rpm.

This process produced pile yarn with a RKm of 24.0 with RKm CV% 7.45 and 7.06% elongation having count CV % 1.02, total impurity per km of 7.6, a hairiness index on COP of 6.95, and a hairiness index on cone of 8.5. RKm stands for resistance to kilometer, i.e. the number of kilometers of yarn required to be hung from one end so that the yarn breaks due to its own weight. CV% refers to coefficient of variation of such yarn strength. The lower CV% is preferred for better performance in subsequent processes.

The 12s combed cotton yarn was assembled on PS Mettler Assembly Winder with PVA spun yarn. The PVA spun yarn had the following properties: 72 s count, 33.4 TPI, 4.0 TM, 2850 CSP, and 18.5 RKm. The spun PVA yarn was made from 1.4 denier×38 mm bright PVA fiber, which dissolved at 90° C.

The Assembly Winder ran at 450 rpm, with PVA spun yarn at a tension of 0 and 12s combed yarn at tension of 4 index. The cotton yarn and PVA yarn were twisted on a TFO Twister running at 10,500 rpm. The twist was in ‘S’ direction at 8.5 TPI. This produced a yarn with a residual positive TPI of 4.6 (i.e. 13.16−8.5). The yarn contained 85% cotton and 15% PVA, with a resultant count of 10.24. The twisted yarn was wound onto cones and sent to Warping.

Warping was carried out in normal conditions with yarn tension of 40 gms and a speed of 600 rpm.

### Example 2

### Production of Bath-Size, Lint-Free Towels

The PVA/cotton pile yarn produced in Example 1 was woven with 2/20s combed cotton ground warp (8.5 TPI (S); 1176 ends; and a weight of 102.64 g) and two weft yarns, a 12s combed cotton yarn (12.47 TPI (Z); 2250 picks; and a weight of 102.15 gms) and a 2/20s cotton yarn (8.5 TPI (S); 492 picks, and a weight of 26.80 gms). The loom was run at 280 rpm. Table 6 lists the specifications for the weaving process.

TABLE 6
On loom specifications

| Reed space for terry | 87.07 cm |
|---|---|
| Reed space for towel | 92.07 cm |
| Number of towels per Reed Space | 3 |
| Reed space utilization | 282.20 cm |
| Pile Ratio | 6.71 |
| Pile height | 6.3 mm |
| Warp cover factor | 18.98 (ground) |
| Weft cover factor | 11.74 |
| Reed/cm | 11.81 |
| Picks/Inch | 40.64 |
| Type of Terry | 3 pick |
| Rpm | 250 |
| Finished Reed/inch pile | 34.53 |

The properties of the fabric when it is removed from the loom, i.e. the grey towel, are listed in Table 7.

TABLE 7
Grey Towel Specifications

| | | |
|---|---|---|
| Grey width | 84.46 | cm |
| Grey length | 151.0 | cm |
| Weight of towel | 785.35 | g |
| Plain portion in width | 5 | cm |
| Plain portion in length | 8 | cm |
| Weight of Grey Towel | 785.35 | g |
| Terry portion in length | 133.0 | cm |
| Selvedge to selvedge width | 89.46 | cm |

After the weaving, the fabric roll was scoured and dyed in the normal fashion at 120° C. in the fabric dyeing machine with a liquor ratio of 1:30. This high liquor ratio was essential to ensure the complete dissolution of Spun PVA yarn. Then, the liquor was drained at 120° C. The material was rinsed a second time by pumping in water at a temperature of 95 to 100° C.

The washed rope was then passed through padding mangle and padded with DMDHU at 25 g/L, a resin with a catalyst magnesium chloride at 7.5 g/L, Soft touch Softener at 5 g/L, and Turbex CAN at 10 g/L to prevent loss of fiber strength. The padded material was hydro-extracted in the normal way.

The rope was untwisted in the rope opener. The material was then dried two times. The opened and spread material was passed through a hot air dryer (e.g. Alea), which was equipped with drum beaters at both the feed and delivery ends, to properly lift the pile. The first drying was carried out at 120° C. The second drying was carried out at 150° C. for 4 to 5 minutes. The full width fabric was then passed through a hot air stenter, which was attached with a weft straightener, to recover the dimensions of the towel.

After drying and straightening, the towels were passed through the shearing machine on both the sides. The blade was set such that only protruding fibers were cut, and the piles were not cut. The fabric was then carried through length cutting, length hemming, cross cutting, cross hemming, and folding according to standard procedures. The properties of the finished lint-free towel are listed in Table 8.

TABLE 8
Finished Towel Specifications

| | |
|---|---|
| Dimensions | 76 cm × 142 cm |
| Plain portion in width | 5.0 cm |
| Terry portion in width | 74.8 cm |
| GSM | 604 |
| Weight of finished towel | 651.84 g |
| Weight of Grey Towel | 785.35 g |
| Weight loss (%) | 17% |
| Plain portion in length | 8.0 cm |
| Design portion in length | 10.0 cm |
| Terry portion in length | 133.0 cm |
| Shrinkage % | 16.4% |
| Finished width of towel | 79.60 cm |

It must be noted that as used herein and in the appended claims, the singular forms “a ”, “an”, and “the” include plural reference unless the context clearly dictates otherwise. Unless defined otherwise, all technical and scientific terms used herein have the same meanings as commonly understood by one of skill in the art to which the disclosed invention belongs. Although any methods and materials similar or equivalent to those described herein can be used in the practice or testing of the present invention, the preferred methods, devices, and materials are as described.

Those skilled in the art will recognize, or be able to ascertain using no more than routine experimentation, many equivalents to the specific embodiments of the invention described herein. Such equivalents are intended to be encompassed by the following claims.

We claim:

1. A process for forming a lint-free towel comprising
selecting a filament made of a water-soluble material twisted with cotton pile yarn,
weaving the water-soluble filament twisted with cotton pile yarn with ground warp and weft yarn to form a towel, and
dissolving the water-soluble filament in the towel.

2. The process of claim 1, wherein the water-soluble filament has a count of 31 Dtex, 40 Dtex, 44 Dtex, 62 Dtex, or 84 Dtex.

3. The process of claim 1, wherein the cotton pile yarn has an Uster hairiness index of 5 to 7.5.

4. The process of claim 1, wherein the dissolving step comprises washing the towel in water at a temperature of 120° C.

5. The process of claim 4, further comprising a second washing in water at a temperature of 95° C.

6. The process of claim 1, wherein the water-soluble material is polyvinyl alcohol.

7. The process of claim 6, wherein the polyvinyl alcohol is spun polyvinyl alcohol yarn obtained from polyvinyl alcohol staple fibers of 1.4 denier by 38 mm.

8. The process of claim 7, wherein the spun polyvinyl alcohol has a count of Ne 40s, 60s, or 70s.

9. The process of claim 1, wherein the cotton pile yarn is 100% cotton.

10. A pile yarn comprising a water-soluble filament twisted with cotton yarn, wherein the water-soluble filament is capable of dissolving in water a temperature ranging from 55° C. to 95° C., and
wherein the cotton yarn has a Uster hairiness index within the range of 5 to 7.5.

11. The pile yarn of claim 10, wherein the water-soluble filament has a count of 31 Dtex, 40 Dtex, 44 Dtex, 62 Dtex, or 84 Dtex.

12. The pile yarn of claim 10, wherein the cotton pile yarn has a count of 10s, 12s, 14s, 16s, 18s, or 2/24s.

13. The pile yarn of claim 10, wherein the water-soluble filament comprises polyvinyl alcohol.

14. The pile yarn of claim 13, wherein the polyvinyl alcohol is spun polyvinyl alcohol yarn obtained from polyvinyl alcohol staple fibers of 1.4 denier by 38 mm.

15. The pile yarn of claim 14, wherein the spun polyvinyl alcohol has a count of Ne 40s, 60s, or 70s.

16. The pile yarn of claim 10, wherein the cotton filament is 100% cotton.

17. A lint-free towel comprising 100% cotton pile yarn, wherein the pile yarn has a Uster hairiness index within the range of 5 to 7.5.
